(19) United States
(12) Patent Application Publication
(10) Pub. No.: US 2008/0050196 A1
(43) Pub. Date: Feb. 28, 2008

(54) FASTENER ASSEMBLY FOR ATTACHING A HEAT DISSIPATING DEVICE TO AN ELECTRONIC DEVICE

(75) Inventors: JUN CAO, Shenzhen (CN); ZHAN WU, Shenzhen (CN); SHI-WEN ZHOU, Shenzhen (CN); CHUN-CHI CHEN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN TECHNOLOGY CO., LTD., Tu-Cheng (TW)

(21) Appl. No.: 11/616,847

(22) Filed: Dec. 27, 2006

(30) Foreign Application Priority Data
Aug. 25, 2006 (CN) 200610062279.1

(51) Int. Cl. F16B 39/00

(52) U.S. Cl. 411/107

(57) ABSTRACT

A fastener assembly for securing a heat dissipation device to a CPU mounted on a printed circuit board, includes a sleeve, a bolt, and a coil spring. The sleeve includes a hollow body, a top head and a pair of lower resilient flat extensions. The resilient flat extension has a barb projecting outwards therefrom and is deformable radially. The bolt includes a shaft, a joining part at an end thereof and a threaded part formed at an opposite end thereof. The shaft is received in the hollow body of the sleeve with the joining part fastened to the hollow body, whilst the threaded part projects out of the hollow body. The coil spring surrounds the sleeve and is held between the head of the sleeve and the barbs of the sleeve; the coil spring is deformable axially along a length of the sleeve.

### BACKGROUND OF THE INVENTION

1. Field of the Invention

The present invention relates to a fastener assembly, and more particularly to a fastener assembly for attaching a heat dissipating device to an electronic package.

2. Description of Related Art

A heat sink is usually placed in thermal contact with an electronic package, such as a central processing unit (CPU), to transfer heat through conduction away from the electronic package, thus preventing over-heating of the electronic package. One apparatus for attaching the heat sink on the CPU includes four through holes defined in four corners of the heat sink, four threaded holes defined in a retainer, four screws, and four springs. The screws are pushed to extend through the springs and the through holes of the heat sink and a motherboard in order to engage in the threaded holes of the retainer, thereby attaching the heat sink onto the CPU mounted on the motherboard.

However, the screws and the springs are discrete components prior to attachment of the heat sink onto the motherboard. Particularly in mass-production facilities, the assembly process can be time-consuming and inconvenient.

Therefore, an improved apparatus for securing a heat sink to an electronic package, which overcomes the above-mentioned disadvantages is desired.

### SUMMARY OF THE INVENTION

A fastener assembly comprises a sleeve, a bolt, and a coil spring. The sleeve comprises a hollow body and a head at a top of the body; the hollow body comprises a pair of resilient flat extensions at a lower portion thereof. The resilient flat extension has a barb projecting outwards therefrom and is deformable radically. The bolt comprises a shaft, a joining part at an end thereof and a threaded part formed at an opposite end thereof. The shaft is received in the hollow body of the sleeve with the joining part attached to the hollow body, whilst the threaded part projects out of the hollow body. The coil spring surrounds the sleeve and is held between the head of the sleeve and the barbs of the sleeve; the coil spring is deformable axially along a length of the sleeve. When assembled to a fixing ear of a heat spreader of a heat dissipating device, the barbs engage a bottom face of the fixing ear and the coil spring is compressed between the head of the sleeve and a top face of the fixing ear. The heat spreader has a bottom face for thermally engaging with a CPU mounted on a printed circuit board. The threaded part of the bolt is used for threadedly engaging with a back plate at a bottom of the printed circuit board.

Other advantages and novel features will become more apparent from the following detailed description of preferred embodiments when taken in conjunction with the accompanying drawings, in which:

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an exploded view of a fastener assembly in accordance with a preferred embodiment of the present invention, together with a heat dissipating device;

FIG. 2 is an enlarged exploded view of the fastener assembly in FIG. 1;

FIG. 3 is an assembled view of FIG. 1; and

FIG. 4 is a cross section view of the fastener assembly through a line IV of FIG. 3.

### DETAILED DESCRIPTION OF THE INVENTION

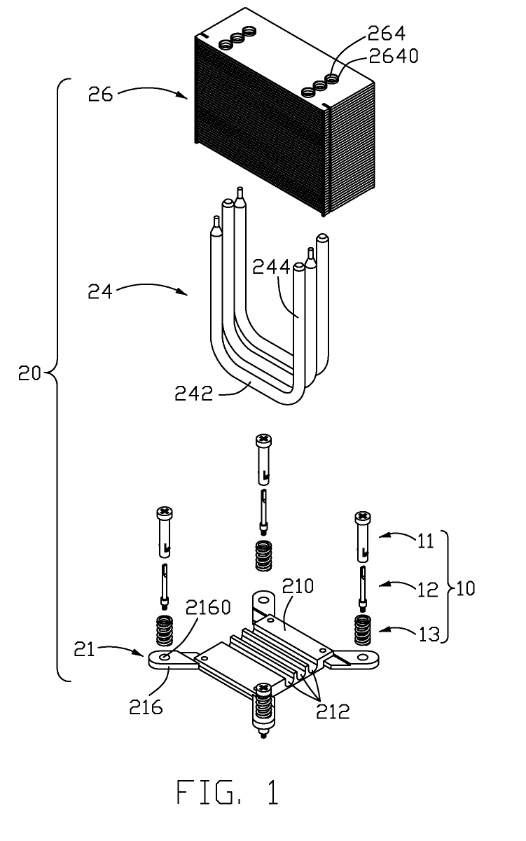

Referring to FIGS. 1-4, a fastener assembly 10 in accordance with a preferred embodiment of the present invention is illustrated. The fastener assembly 10 is used to secure a heat dissipating device 20 to an electronic package such as a CPU (not shown) mounted on a printed circuit board (not shown).

The heat dissipating device 20 comprises a heat spreader 21, three heat pipes 24 and a plurality of fins 26. The heat pipes 24 thermally connect the heat spreader 21 and the fins 26 together.

The heat spreader 21 has a rectangular main body 210, which contacts the CPU mounted on the printed circuit board. The main body 210 defines three parallel and spaced grooves 212 on a top surface thereof, for receiving some portions of the heat pipes 24. Fixing ears 216 outwardly and symmetrically extend from each of four corners of the main body 210, and each define a mounting hole 2160 adjacent to a distal end thereof for engaging with the fastener assembly 10.

The fins 26 are all oriented parallel to the heat spreader 21, spaced from and snapped with each other. Each fin 26 is perforated with through orifices 264. Each of the through orifices 264 has an annular sidewall 2640 that is formed during punching the through orifice 264. All the annular sidewalls 2640 in line incorporate the corresponding through orifices 264 to form an accommodating channel (not label) for receiving another portion of the heat pipes 24.

The heat pipes 24 each comprises an evaporating portion 242 and a pair of condensing portions 244 extending perpendicularly from two opposite ends of the evaporating portion 242. The evaporating portions 242 of the heat pipes 24 are soldered in the grooves 212 of the heat spreader 21, for adsorbing the heat accumulated at the spreader 21. The condensing portions 244 of the heat pipes 24 are soldered in the associated accommodating channels formed by the through orifices 264 and the annular sidewalls 2640 of the fins 26, for transferring the heat absorbed by the evaporating portions 242 of the heat pipes 24 to the fins 24 symmetrically.

The fastener assembly 10 comprises a sleeve 11, a bolt 12, and a resilient component, such as a coil spring 13. The bolt 12 is inserted into the sleeve 11 and the coil spring 13 closely surrounds the sleeve 11.

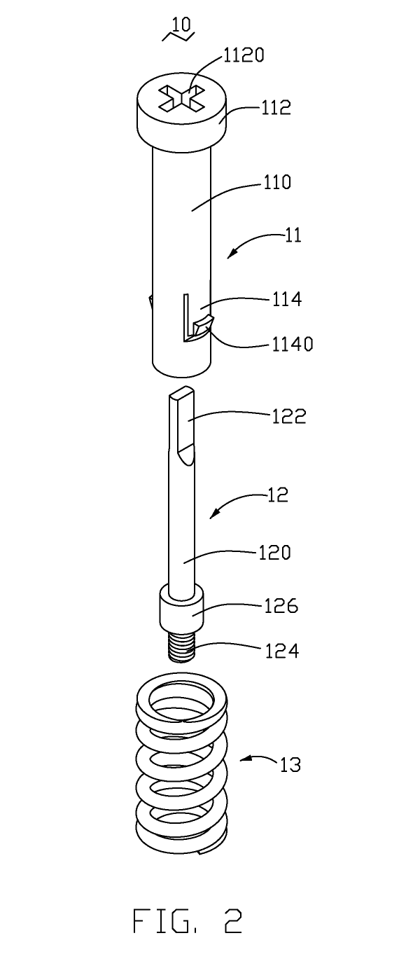

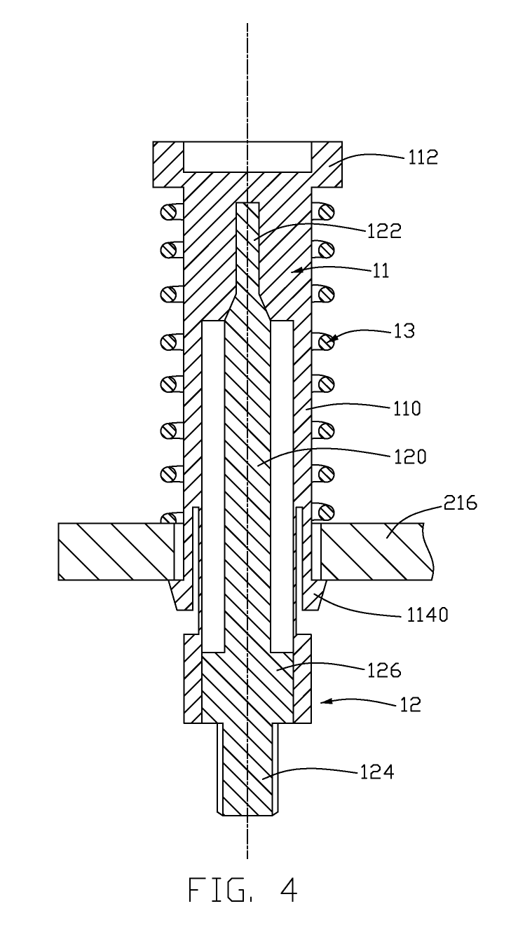

Particularly referring to FIG. 2, the sleeve 11 is formed from a molded elastic plastic, and comprises an elongated hollow body 110 and a circular head 112 formed at a top edge of the body 110. The head 112 has a diameter larger than that of the hollow body 110, and defines a cross-shaped slot 1120 for engaging with a screwdriver (not shown) to rotate the sleeve 11. A pair of locking structures, such as two rectangular resilient flat extensions 114, is formed at a lower portion of the hollow body 110 and opposite to each other. The resilient flat extensions 114 are cut off from the hollow body 110 on three sides, with only an upper side left uncut, and have a pair of barbs 1140 respectively extending upwardly and outwards from lower portions thereof. The resilient flat extensions 114 are deformable radially when the corresponding barbs 1140 are urged inwards. Also referring to FIG. 4, the hollow body 110 defines an engaging portion (not label) therein, which is adjacent to the head 112 of the sleeve 11. The engaging portion has an elongated slot (not labeled) coaxial with the sleeve 11, for combining with the bolt 12.

The bolt 12 is made of metal, and has a shaft 120 extending in the hollow body 110 of the sleeve 11, a joining part 122 at an upper end thereof and a threaded part 124 at an opposite lower end thereof. A cross section of the joining part 122 is desired to be any configuration other than perfectly circular. In this embodiment, it is rectangular in shape for preventing the bolt 12 from rotating relative to the sleeve 11 when in combination with the sleeve 11. The shaft 120 defines a fixing post 126 at a joint with the threaded part 124 and above the threaded part 124. The fixing post 126 has a diameter larger than that of the shaft 120 and slightly smaller than an inner diameter of the hollow body 110 of the sleeve 11; thus, the fixing post 126 can be snuggly received in the hollow body 110.

When assembled, the bolt 12 is received in the sleeve 11 with the joining part 122 of the bolt 12 inserted into the slot of the engaging portion of the sleeve 11. The joining part 122 fits interfereningly into the engaging portion; thus, the sleeve 11 and the bolt 12 are securely connected together. The post 126 of the bolt 12 is perfectly accommodated in the hollow body 110 of the sleeve 12, at the same time, the threaded part 124 of the bolt 12 is wholly positioned outside of the hollow body 110 of the sleeve 12. The coil spring 13 encircling the sleeve 12 is loosely held between the head 112 of the sleeve 12 and the barbs 1140 of the resilient flat extensions 114 of the sleeve 12. Thus, the fastener assembly 10 is pre-assembled prior to being attached to one of the fixing ears 216 of the heat spreader 21.

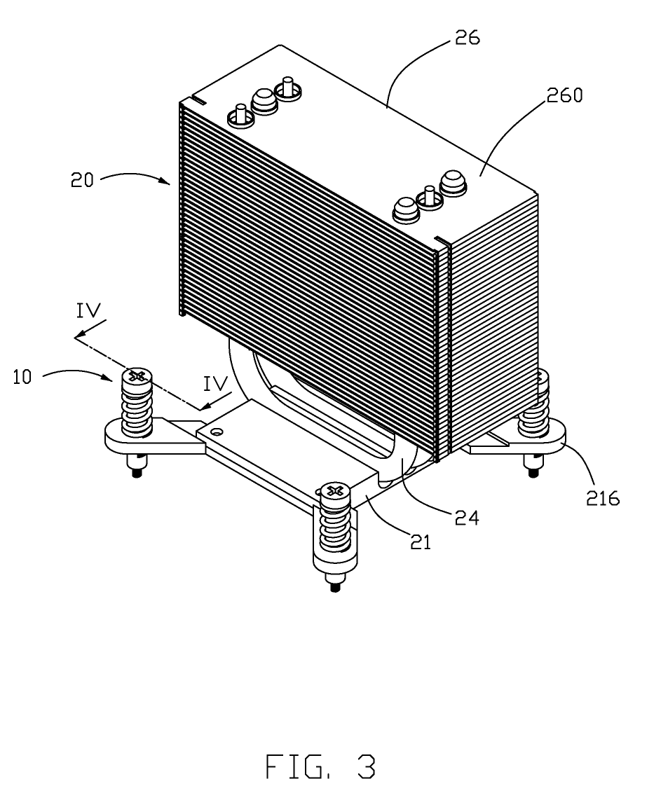

Also referring to FIGS. 3-4, in the process of mounting the fastener assemblies 10 to the heat dissipating device 20, the pre-assembled fastener assemblies 10 are installed into the associated mounting holes 2160 of the fixing ears 216 of the heat spreader 21 of heat dissipating device 20, with bottoms of the resilient flat extensions 114 of the sleeves 11 resting on a top surface of the fixing ears 216 of the heat dissipating device 20 around the mounting holes 2160. The fastener assemblies 10 are then pressed downwards to force the barbs 1140 of the resilient flat extensions 114 to move inwards to pass through the mounting holes 2160. Subsequently, the barbs 1140 return to their original states and are locked beneath the fixing ears 216 of the heat dissipating assembly 20. At this time, the coil springs 13 are compressed between the heads 112 of the sleeves 11 and the fixing ears 216, and exert a downward force on the fixing ears 216. The fastener assemblies 10 are thus pre-mounted on the heat dissipating assembly 20 and eliminate a risk of disengaging from the heat dissipating assembly 20. To secure the heat dissipating device 20 to the CPU mounted on the printed circuit board, the threaded parts 124 of the bolts 12 of the fastener assemblies 10 are screwed downwards to engage a retainer, i.e., a back plate (not shown) located beneath the printed circuit board, so as to firmly secure the heat dissipating assembly 20 on the printed circuit board, whereby a bottom surface of the rectangular body 210 of the heat spreader 21 can have an intimate contact with the CPU.

As described above, the fastener assembly 10 is pre-assembled to form a module. Installation or removal of the fastener assembly 10 is thus both quick and simple. Additionally, the coil springs 13 serve to lessen vibrations; therefore, the heat dissipating device 20 can be securely fastened in the desired position on the printed circuit board and will not be unduly subjected to vibration.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A fastener assembly for securing a heat dissipating device to a printed circuit board, comprising:
a sleeve comprising a hollow body and a head at a top portion of the body, the hollow body comprising a pair of resilient flat extensions at a lower portion thereof, wherein the resilient flat extension has a barb projecting outwards therefrom and is deformable radially;
a bolt comprising a shaft, a joining part at an end thereof and a threaded part formed at an opposite end thereof adapted for threadedly engaging with a retainer of the printed circuit board, the shaft being received in the hollow body of the sleeve with the joining part attached to the hollow body, whilst the threaded part projects out of the hollow body; and
a resilient component held between the head of the sleeve and the barbs of the sleeve.

2. The fastener assembly as claimed in claim 1, wherein the resilient flat extension is rectangular in shape and is cut off from the hollow body on three sides and not on an upper side.

3. The fastener assembly as claimed in claim 1, wherein the hollow body of the sleeve defines an engaging portion therein, which is adjacent to the head of the sleeve.

4. The fastener assembly as claimed in claim 3, wherein the engaging portion of the sleeve fits interferingly with the joining part of the bolt.

5. The fastener assembly as claimed in claim 4, wherein a cross section of the joining part can be any non-circular shape for preventing rotation of the bolt relative to the sleeve.

6. The fastener assembly as claimed in claim 5, wherein a cross section of the joining part is rectangular in shape.

7. The fastener assembly as claimed in claim 1, wherein the shaft defines a fixing post at a joint with the threaded part, which is snugly received in the hollow body of the sleeve.

8. The fastener assembly as claimed in claim 1, wherein the sleeve is formed from an elastic plastic, and the bolt is made of metal.

9. The fastener assembly as claimed in claim 1, wherein the resilient component is a coil spring encircling the sleeve and deformable axially along a length of the sleeve.

10. An electronic device assembly, comprising:
a heat dissipating device comprising a heat spreader, the spreader has a plurality of fixing ears outwards and symmetrically extending therefrom, each fixing ears defines a mounting hole therein; and
a plurality of pre-assembled fastener assemblies respectively extending through the mounting holes of the heat dissipating device, each fastener assembly comprising:
a sleeve comprising a hollow body disposed within the mounting hole and a head at a top of the body, the hollow body comprising a pair of resilient flat extensions at a lower portion thereof, wherein the resilient flat extension has a barb projecting outwards therefrom and is locked beneath the fixing ear of the heat dissipating assembly;
a bolt comprising a shaft, a joining part at an end thereof and a threaded part formed at an opposite end thereof, wherein the shaft is received in the hollow body of the sleeve with the joining part attached to the hollow body, whilst the threaded part projecting out of the hollow body; and
a coil spring encircling the sleeve and compressed between the head of the sleeve and the fixing ear of the heat dissipating device.

11. The fastener assembly as claimed in claim 10, wherein the resilient flat extension is rectangular in shape and is cut off from the hollow body on three sides thereof.

12. The fastener assembly as claimed in claim 10, wherein the hollow body of the sleeve defines an engaging portion therein, which is adjacent to the head of the sleeve.

13. The fastener assembly as claimed in claim 12, wherein the engaging portion of the sleeve fits intereferingly with the joining part of the bolt so that the sleeve and the bolt are securely connected together.

14. The fastener assembly as claimed in claim 13, wherein a cross section of the joining part can be any non-circular shape for preventing rotation of the bolt in the sleeve.

15. The fastener assembly as claimed in claim 14, wherein a cross section of the joining part is rectangular in shape.

16. The fastener assembly as claimed in claim 10, wherein the shaft defines a fixing post at a joint with the threaded part, which is snugly received in the hollow body of the sleeve.

17. The fastener assembly as claimed in claim 10, wherein the sleeve and the bolt are made of different material.

18. The fastener assembly as claimed in claim 17, wherein the sleeve is formed from a molded elastic plastic, and the bolt is made of metal.

19. The fastener assembly as claimed in claim 12, wherein the engaging portion of the sleeve comprises an elongated slot, and the joining part of the bolt is interferentially inserted in the elongated slot.
